(19) United States
(12) Patent Application Publication
(10) Pub. No.: US 2014/0131201 A1
(43) Pub. Date: May 15, 2014

(54) PROCESS FOR MAKING AMMONIA GAS INDICATOR USING SINGLE WALL CARBON NANOTUBE/ALUMINA COMPOSITE THICK FILM

(71) Applicants: Jamia Millia Islamia, New Delhi (IN); Department of Electronics & Information Technology, New Delhi (IN)

(72) Inventors: Prabhash Mishra, New Delhi (IN); Saikh Saiful Islam, New Delhi (IN); Kamalendu Sengupta, New Delhi (IN)

(73) Assignees: Jamia Millia Islamia, New Delhi (IN); Department of Electronics & Information Technology, New Delhi (IN)

(21) Appl. No.: 14/051,148

(22) Filed: Oct. 10, 2013

(30) Foreign Application Priority Data
Nov. 12, 2012 (IN) 3505/DEL/2012

(51) Int. Cl. G01N 27/403

(52) U.S. Cl. CPC G01N 27/403; B82Y 40/00
USPC 204/432; 427/113; 977/890; 977/781; 977/902

(57) ABSTRACT

The invention relates to a process of making ammonia gas indicator, using single wall carbon nanotubes (SWCNTs)/alumina (Al2O3) composite thick film, comprising the steps of (a) preparing a nanoporous SWCNTs/Al2O3 composite thick film of thickness in the range of 60 to 65μm prepared by sol-gel process; (b) curing the film at a temperature in the range of 450° C. to 500° C. for a time period in the range 0.5 to 2 hour to obtain a cured sample; (c) providing thick film planar electrodes of Ag—Pd paste on same side of the cured sample by screen printing; and (d) heat treating the resultant cured sample with electrodes at a temperature in the range of 800° C. to 850° C. for a time period in the range of 0.5 to 2 hours to obtain a gas indicator.

### FIELD OF THE INVENTION

The present invention relates to a process for manufacturing an ammonia gas indicator useful for the determination of trace ammonia present in gases and a device incorporating the said ammonia indicator. The invention particularly relates to a novel indicator capable of determination ammonia present in gases in trace amounts of the order of less than 1 ppm.

### BACKGROUND OF THE INVENTION

In industry, gases such as ammonia are widely used and the amount content of such gases needs to be monitored. At present, measurement of ammonia in other gases are widely used in various scientific ways and amount such as less than 1 ppm level plays a vital role in the process. A few common examples are where specific range of gas is necessary for the continuous monitoring of gas in material preparation in glove boxes. Other applications wherein determination of trace ammonia present in gases is required are related to agricultural industries, fertilizer industry, metal treating operations, industrial refrigeration systems, rubber industry, pulp and paper industry, food and leverage industry and lather industry.

In the hitherto known prior art, there are a number of ammonia gas indicators which are commonly available and also disclosed in patent literature.

At present, the commercial trace ammonia gas sensors available in the market are devices for trace ammonia sensing which are electrochemical type sensor.

The commercially available ammonia sensors in the market are such as Mil-Ram technology gas detection system (USA), Professional Equipment (USA), Henan henwei Electronics co. Ltd. (China). They are the prime manufacturers of ammonia gas sensors available in the market and all of them are manufacturing following electrochemical technology. Electrochemical diffusion type gas sensors are gas indicators that measure the concentration of a target gas by oxidizing or reducing the target gas at an electrode and measuring the resulting current. The method suffers from various limitations such as temperature drift (20-50° C.), and saturation when exposed to high gas concentration and of high cost.

U.S. Pat. No. 6,997,039 titled “CARBON NANOTUBE BASED RESONATOR CIRCUIT SENSOR” relates to resonant gas sensors and method for forming and using the disclosed sensors. The sensors include a resonator including a layer comprising adsorptive nanostructures, for example carbon nanotubes, activated carbon fibers, or adsorptive nanowires. The dielectric of the resonator is in electrical communication with the layer comprising adsorptive nanostructures such that the effective resonance frequency of the resonator depends on both the dielectric as well as dielectric constant of the absorptive layer.

U.S. Pat. No. 8,052,855 titled “CARBON NANOTUBE GAS SENSOR AND METHOD OF MANUFACTURING THE SAME” highlights a carbon nanotube (CNT) gas sensor which includes a substrate, an insulating layer formed on the substrate, electrodes formed on the insulating layer, and CNT barriers that protrude higher than the electrodes in spaces between the electrodes to form gas detecting spaces. A method of manufacturing the gas sensor includes forming an insulating layer on a substrate, forming an electrode pattern on the insulating layer, coating CNT paste having a thickness greater than a thickness of electrodes in the electrode pattern on the electrodes and the insulating layer, and patterning and firing the carbon nanotubes paste, including using photolithography method, to retain only portions of the CNT paste coated on spaces between the electrodes.

US Patent Application Publication No. US 2007/0158209A1 titled “GAS SENSOR AND METHOD THEREOF” focuses on a gas sensor which may include first and second electrodes formed on a substrate, a carbon nanotube connecting the first and second electrodes on the substrate, a light source disposed above the carbon nanotube and an ampere meter measuring current flowing between the first and second electrodes. The example method may be directed to identifying a gas, and may include measuring a first current responsive to a first applied voltage during a first mode of operation, comparing the first measured current with a plurality of first index current values to obtain a first comparison result, each of the plurality of first index current value associated with one of a plurality of gases, measuring a second current responsive to a second applied voltage during a second mode of operation, comparing the second measured current with a plurality of second index current values to obtain a second comparison result, each of the plurality of second index current values associated with one of the plurality of gases. And determining gas characteristic information based on the first and second comparison result.

US Patent Application Publication No. US 2008/0034842A1 titled “GAS SENSOR USING CARBON NANOTUBE AND METHOD OF MANUFACTURING THE SAME” describes a gas sensor which includes a substrate having a plurality of through holes, a pair of electrodes disposed on the substrate, wherein the plurality of through hole are disposed between the pair of electron and a plurality of carbon nanotube covering at least a portion of the plurality of carbon nanotubes in connected with the pair of electrodes.

A reference may be made to US Patent Application Publication No. US 2008/0274559A1 titled “GAS SENSOR FOR DETERMINING AMMONIA” wherein the invention relates to a gas sensor which in used to detect ammonia by detecting and evaluating conductivity variation on semiconducting metal oxide, comprising : a substrate, a gas sensitive layer made of semi conductive metal oxide, a catalytic filler which is disposed in front of metal oxide, said filter being used to convert ammonia, contained in the measuring gas, into a NO/NO2 mixture or to only NO2, measuring electrodes which are arranged on the surface of the substrate in order to detect conductivity variation in the semi-conductive metal oxide which is at least sensitive to NO/NO2, a controllable electric heating device which is used to adjust predetermined temperatures at least for the semi conductive metal oxide, whereby the formed NO/NO2 can be guided to the metal oxide and the content of ammonia in the measuring gas can be determined from the NO/NO2 measurement by means of the semi-conductive metal oxide.

Another reference may be made to US Patent Application Publication No. US 2010/0032292A1 titled “AMMONIA GAS SENSOR” which relates a single-cell sensor element is configured for ammonia gas sensing, the sensor includes an electrolyte layer, an NH3 sensing electrode and a NOx sensing electrode. The NH3 sensing electrode is sensitive to NH3 but is also vulnerable to cross-intoference from NO2. To directly correct for this cross-interference, a second (NOx) electrode is provided and is used in a differential connection arrangement with the NH3 sensing electrode. The NOx sensing electrode has a first electrochemical sensitivity to NO2 that is greater than second and third electrochemical sensitivities to NH3 or NO, respectively. The NOX sensing electrode may have low or no sensitivity to NH3 or NO. The sensor element also includes first and second electrical leads respectively connected to the NH3 and NOx sensing electrodes. The output signal developed across the first and seconds leads is directly indicative of an ammonia concentration in a gas exposed to the NH3 and NOx sensing electrodes, thereby eliminating the need for emf selection rule to be programmed into an electric controller to which the sensor is connected.

The disadvantages of the ammonia gas sensors which are commercially available and also disclose in patent literature include:
1. Available ammonia gas sensors are based on electrochemical sensing techniques.
2. The processes are costly.
3. The sensor has problems of cross-sensitivity.
4. Regular calibration is required.
5. Correct operation depends on presence of defined level of oxygen and humidity.
6. Limited life time.

The present invention overcomes these and other disadvantages in the prior art and provides a process of manufacturing a gas indicator useful for the determination of trace ammonia gas present in gases and a device incorporating the said gas indicator for measuring trace ammonia gas present in other gases.

### SUMMARY OF THE INVENTION

Embodiments of the invention provide a process of manufacturing ammonia gas indicator useful for the determination of trace gas present in atmosphere or other carrier gases.

Embodiments of the invention provide a process of manufacturing an ammonia gas indicator useful for the determination of trace ammonia amount of the order of <1 ppm present in gas or environment.

In embodiments, the invention is a process of manufacturing an ammonia gas indicator which works with high sensitivity in the range of 1-40 ppm level.

Embodiments of the invention include a process of manufacturing an ammonia gas indicator which works with 0.05 ppm resolution.

In embodiments, the invention provides a process of manufacturing an ammonia gas indicator which has a response time of <1 minute.

Embodiments of the invention provide a low cost process of manufacturing a gas indicator useful for the determination of trace ammonia present in gases.

In embodiments the present invention provides a process of manufacturing a gas indicator having temperature stability over the working range.

Embodiments of the present invention is provide a process of manufacturing a gas indicator fabricated from single wall carbon nanotube (SWCNTs)/ Ceramic (Al2O3) composite thick film developed by gel cast technique.

In embodiments, the present invention provides a process of manufacturing a gas indicator which has capability of being regenerated.

Embodiments of the present invention provide a process of manufacturing a gas indicator which is capable of maintaining calibration over a period of time.

In some embodiments, the present invention is a device incorporating the said gas indicator of the present invention.

The invention includes a process of making ammonia gas indicator, using single wall carbon nanotubes (SWCNTs)/alumina (Al2O3) composite thick film. The process can include the steps of (a) preparing a nanoporous SWCNTs/Al2O3 composite thick film of thickness in the range of 60 to 65 μm prepared by sol-gel process; (b) curing the film at a temperature in the range of 400° C. to 650° C. for a time period in the range 0.5 to 2 hour to obtain a cured sample; (c) providing thick film planar electrodes of Ag—Pd paste on same side of the cured sample by screen printing; and (d) heat treating the resultant cured sample with electrodes at a temperature in the range of 800° C. to 900° C. for a time period in the range of 0.5 to 2 hours to obtain a gas indicator. The curing of the film can be effected at a temperature range of, for example, about 450° C. to about 600° C. In embodiments, the nanoporous SWCNTs/Al2O3 composite thick film is prepared from Al-Sec-Butoxide dissolved in water in the presence of conc. HNO3, by hydrolysis and refluxing following conventional sol-gel process. The quantity of Al-Sec-Butoxide, water and concentrated HNO3 can be of the order of 40 gm, 300 cc and 1.44 cc respectively, or a similar ratio thereof. The curing of the film may be effected at a temperature in the range of 450° C. to 500° C. attained at a rate of 20° C./hour. The heat treatment of the cured sample with electrodes can be effected by firing at a temperature in the range of 800° C. to 850° C. attained at a rate of 50° C./hour. The nanoporous SWCNTs/Al2O3 composite thick film can have a dielectric constant of, for example, about 50 to 100 and/or a pore size less than, for example, about 10 nm.

The invention is also a gas indicator teat includes comprising a cured nanoporous SWCNTs/Al2O3 composite thick film and thick film planar electrodes of Ag—Pd. A gas indicator according to the invention can have a sensitivity in the range of 0.5 to 40 ppm level and/or a resolution of the order of 0.05 ppm, and/or a response time of <1 minute. The nanoporous SWCNTs/Al2O3 composite thick film oc the gas indicator can have a dielectric constant of about 50 to 100 and/or a pore size less than 10 nm.

The foregoing has outlined some of the pertinent aspects of embodiments of the invention. These embodiments should not be construed to narrow the invention but are illustrative of some of its more prominent features and applications. Many other beneficial results can be obtained by applying the disclosed invention in a different manner or modifying the invention within the scope of disclosure.

Accordingly, other objectives and a full understanding of the invention and the detailed description of the preferred embodiment in addition to the scope of invention are to be defined by the claims undertaken.

These and other objectives and advantages of the invention will be apparent from the ensuing description.

### DETAILED DESCRIPTION OF THE INVENTION

At the outset of the description, which follows, it is to be understood that the ensuing description only illustrate a particular form of the invention. However, such a particular form is only an exemplary embodiment and the teachings of the invention are not intended to be taken restrictively.

For the purpose of promoting and understanding of the principles of the invention, reference is now to be made to the embodiments illustrates and the specific language would be used to describe the same. It is nevertheless to be understood that no limitations of the scope of the invention is hereby intended, such alterations and further modifications in the illustrated bag and such further applications of the principles of the invention as illustrated therein being contemplated as would normally occur to one skilled in the art to which the invention relates.

According to the invention there is provided a process of making ammonia gas indicator, using single wall carbon nanotubes (SWCNTs)/alumina (Al2O3) composite thick film, including one or more the steps of

(a) preparing a nanoporous SWCNTs/Al2O3 composite thick film of thickness in the range of 60 to 65μm prepared by sol-gel process;

(b) curing the film at a temperature in the range of about 400° C. to about 650° C., for example, about 450° C. to about 600° C. or about 450° C., about 500° C. or about 600° C. for a time period in the range 0.5 to 2 hours, for example about 0.5 to about 1.5 hours to obtain a cured sample;

(c) providing thick film planar electrodes of Ag—Pd paste on same side of the cured sample by screen printing; and

(d) heat treating the resultant cured sample with electrodes at a temperature in the range of about 800° C. to about 900° C., for example about 800° C. to about 850° C. or about 850° C. for a time period in the range of 0.5 to 2 hours to obtain a gas indicator.

The novelty of the present invention resides in providing an economical process of manufacturing an ammonia gas indicator. The ammonia gas indicator, so prepared is capable of measuring gas levels In the range of, for example, 0.5-40 ppm with high resolution, for example, of the order of 0.5 ppm. Other novel features of the indicator are that it can be regenerated, has better sensitivity, faster response and better repeatability.

The novel features of the present invention have been realized by the non-obvious inventive steps of preparing a nanoporous composite thick film by gel cast technique, duly cured and provided with planer thick film electrodes on the same side of the material, and subjected to heat treatment to obtain a gas indicator. The gas indicator so obtained measures the change in resistance due to gas absorption of material under test and is capable of being incorporated in a device for measuring ammonia gas from trace of high level with appropriate sensitivity. The resistive type gas indicator of the present invention has been obtained with the inventive step of providing thick film electrode on composite thick film.

Accordingly, the present invention provides a process of manufacturing gas indicator useful for the determination of trace ammonia present in gas mixtures or environmental gases, which comprises preparing a SWCNTs/Al2O3 composite thick film of thickness in the range of 60-65 μm, followed by curing the green (as grown) film at a temperature in the range of 400° C. to 650° C. for a time period in the range 0.5 to 1.5 hour to obtain a cured nanoporous film, providing thick film planer electrodes on same side of the cured sample by screen printing, heat treating the resultant cured sample with electrodes at a temperature in the range of 800° C. to 850° C. for a time in the range of 0.5 to 2 hour to obtain gas indicator.

In an embodiment of the present invention, the film is prepared from SWCNTs/Al2O3 composite by using gel cast technique.

In embodiments of the present invention, the nanoporous composite thick film has pore size less than 10 nm due to curing process.

In some embodiments of the present invention, the nanoporous composite thick film is of thickness in the range of 60 to 65 μm.

In embodiments of the present invention, the nanoporous composite thick film has dielectric constant of the order of 50 to 100.

In embodiments of the present invention, the nanoporous composite thick film of thickness 60 to 65 μm is prepared from Al-Sec-Butoxide dissolved in water in presence of concentrated HNO3, wherein the quantity of Al-Sec-Butoxide, water and concentrated HNO3 are of the order of 40 gm, 300 cc and 1.4 cc, respectively, or a similar ratio thereof.

In embodiments of the present invention, the curing of the gel cast film is effected at a temperature in the range of 450° C. to 500° C., attained at the rate of 20° C./h and maintained at a temperature in the range of 450° C. to 500° C. for a time period in the range of 0.5 to 2 hour.

In embodiment of the present invention, the thick film planer electrodes of Ag—Pd paste are provided on same side of the said cured sample by screen printing.

In embodiments of the present invention, the heat treatment of the cured sample with electrodes is effected by firing at a temperature in the range of 800° C. to 850° C., attained at the rate of 50° C./h and maintained at a temperature in the range of 800° C. to 850° C. for a time period in the range of 0.5 to 2 hour.

In some embodiments of the present invention, the gas indicator has sensitivity in the range of 1-40 ppm level.

In embodiments of the present invention, the gas indicator has resolution of the order of 0.05 ppm.

In some embodiments of the present invention, the gas indicator has a response time <1 minutes.

Accordingly, the present invention provides a device incorporating the gas indicator as herein above described, for the determination of trace ammonia gas present in other gases and environment.

In an embodiment of the present invention, the device incorporating the gas indicator includes conventional circuit elements such as constant source and a high impedance amplifier.

In embodiments of the present invention, an analog or digital output display is connected to the gas indicator.

The process of the invention includes essentially consists of preparing single wall carbon nanotube (SWCNTs)/Al2O3 (Ceramic) composite thick film developed by gel cast technique. The composite, prepared through sol-gel process, is duly cured and provided with planer thick film electrodes on same side of the material, and subjected to heat treatment to obtain a gas indicator. The gas indicator measures the change in resistance due to ammonia gas absorption of the material under being tested and is capable of being incorporated into a device for measuring gas from trace to high level with appropriate sensitivity.

The working principle of the gas indicator of the present invention is that the resistance of the indicator changes with the adsorption of gas on SWCNTs reinforced in the composite. The alumina is believed to have no role in gas sensing; it only gives SWCNTs a stable and rigid platform by reinforcing SWCNTs in it. The change in resistance is measured in terms of voltage. The indicator is capable to measuring gas concentration from high to low level. The uniqueness of the present invention includes the fact that the indicator shows good sensitivity in the range of 0.5 to 40 ppm.

The process step of the present invention are:

1. Preparing a nanoporous composite thick film (produced by gel cast technique) of thickness 60-65 μm from Al-Sec-Butoxide dissolved in water in the presence of concentrated HNO3, the sol is mixed with binder for gel cast, wherein the quantity of Al-Sec-Butoxide, water and concentrated HNO3 are of the order of 40 gm, 30 cc and 1.4 cc respectively or ratio thereof.

2. Curing the green thick film so obtained at a temperature in the range of 450° C. to 500° C. attained at the rate of 20° C./hour and maintained at a temperature in the range of 450° C. to 500° C. for a time period in the range 0.5 to 2 hour to obtained a cured sample. Alternatively, the film can be cured at a temperature in the range of about 400° C. to about 650° C., for example, about 450° C. to about 600° C. or about 450° C., about 500° C. or about 600° C.; the time period for curing can be, for example, about 0.5 to about 1.5 hours.

3. Providing thick film planar electrodes of Ag—Pd paste on the side of the said cured sample by screen printing.

4. Heat treating the resultant cured sample with electrode by firing at a temperature in the range of 800° C. to 850° C. attained at the rate of 50° C./hour and maintained at a temperature in the range of 800° C. to 850° C. for a time period in the range of 0.5 to 2 hour to obtain a gas indicator. Alternatively, the firing can be at a temperature in the range of about 800° C. to about 900° C., for example about 800° C. to about 850° C. or about 850° C.

5. The gas indicator so obtained can be connected to an electronic circuit which can measure the change in resistance of the indicator due to presence of gas.

The following examples illustrate the invention in the manner in which it may be carried out in practice. However, this should not be construed to limit the scope of the present invention.

### EXAMPLE 1

Nanoporous SWCNTs/Al2O3 composite thick film of thickness 65 μm was prepared, from 40 gm of Al-Sec Butoxide dissolved in 300 cc water with 1.4 cc concentrated HNO3, by hydrolysis and cured at temperature of 450° C. for a period of 2 hours at the rate of 20° C./hour. Ag—Pd conductive paste was screen printed on the same side of the film. After making electrodes, the sample was fired at a temperature of 850° C. at the rate of 50° C./hour and stable at 850° C. for 2 hour. The indicator was connected to an electronic circuit which measured the change in resistance of the indicator. The DC output showed 10 mV for 10 ppm gas and 22 mV for 18 ppm gas.

### EXAMPLE 2

Nanoporous SWCNTs/Al2O3 composite thick film of thickness 65 μm was prepared, from 40 gm of Al-Sec Butoxide dissolved in 300 cc water with 1.4 cc concentrated HNO3, by hydrolysis and refluxing following conventional sol gel process. The film was taken and cured at temperature of 450° C. for a period of 2 hours at the rate of 20° C./hour. Ag—Pd conductive paste was screen printed on the same side of the cured sample. After making electrodes, the sample was fired at a temperature of 850° C. at the rate of 50° C./hour and stable at 850° C. for 1 hour. The indicator was connected to an electronic circuit which measured the change in capacitance of the indicator. The DC output showed 8 mV for 10 ppm gas and 22 mV for 20 ppm moisture.

### EXAMPLE 3

Nanoporous SWCNTs/Al2O3 composite thick film of thickness 65 μm was prepared, from 40 gm of Al-Sec Butoxide dissolved in 300 cc water with 1.4 concentrated HNO3, by hydrolysis and refluxing following conventional sol gel process. The nanoporous film was taken and cured at temperature of 550° C. for a period of 2 hours at the rate of 20° C./hour. Ag—Pd conductive paste was screen printed on the same side of the cured sample. After making electrodes, the sample was fired at a temperature of 850° C. at the rate of 50° C./hour and stable at 850° C. for 1 hour. The indicator was connected to an electronic circuit which measured the change in resistance of the indicator. The DC output showed 10 mV for 10 ppm gas and 16 mV for 20 ppm gas.

### EXAMPLE 4

Nanoporous SWCNTs/Al2O3 composite thick film of thickness 65 μm was prepared, from 40 gm of Al-Sec Butoxide dissolved in 300 cc water with 1.4 cc concentrated HNO3, by hydrolysis and refluxing following conventional sol gel process. The nanoporous film was taken and cured at temperature of 600° C. for a period of 1 hours at the rate of 30° C./hour. Ag—Pd conductive paste was screen printed on the same side of the cured sample. After making electrodes, the sample was fired at a temperature of 850° C. at the rate of 50° C./hour and stable at 850° C. for 1 hour. The indicator was connected to an electronic circuit which measured the change in resistance of the indicator. The DC output showed 10 m V for 12 ppm gas and 15 mV for 25 ppm gas.

Advantages of the gas indicator prepared by the process of the present invention include that it provides one or more of:

1. A low cost process of manufacturing a gas indicator useful for the determination of trace ammonia present in gases.

2. A process having easier control of composition and micro-structure of the deposited coating.

3. A process having easier fabrication of thick film electrodes of Ag—Pd paste which are rigid, having long life, and low contact resistance (p=0.0010 cm), therefore, low dissipation factor.

4. A novel gas indicator for the determination of trace ammonia amount of the order of 0.5 to 40 ppm level present in gases.

5. A novel gas indicator which works with 0.05 ppm resolution.

6. A novel gas indicator which has a response time<1 minutes.

7. A novel gas indicator having temperature stability over working range.

8. A novel gas indicator capable of being regenerated by cleaning with organic solvent.

9. A novel gas indicator capable of maintaining calibration over a period of time.

10. A novel gas indicator can be easily incorporated in a device consisting of conventional circuit elements.

All documents cited in the description are incorporated herein by reference. The present invention is not to be limited in scope by the specific embodiments and examples which are intended as illustration of a number of aspects of the scope of this invention. Those skilled in the art will know or to be able to ascertain using no more than routine experimentation many equivalents to the specific embodiments of the invention described herein.

It is to be further noted that present invention is susceptible to modifications adoptions and changes by those skilled in the art. Such variant embodiments employing the concepts and features of this invention are intended to be within the scope of the present invention which is further set forth under the claims:

We claim:

1. A process of making ammonia gas indicator, using single wall carbon nanotubes (SWCNTs)/alumina (Al2O3) composite thick film, comprising the steps of:
a) preparing a nanoporous SWCNTs/Al2O3 composite thick film of thickness in the range of 60 to 65μm prepared by sol-gel process;
b) curing the film at a temperature in the range of 400° C. to 650° C. for a time period in the range 0.5 to 2 hour to obtain a cured sample;
c) providing thick film planar electrodes of Ag—Pd paste on same side of the cured sample by screen printing; and
d) heat treating the resultant cured sample with electrodes at a temperature in the range of 800° C. to 900° C. for a time period in the range of 0.5 to 2 hours to obtain a gas indicator.

2. The process as claimed in claim 1, wherein curing of the film is effected at a temperature range of about 450° C. to about 600° C.

3. The process as claimed in claim 1, wherein the nanoporous SWCNTs/Al2O3 composite thick film is prepared from Al-Sec-Butoxide dissolved in water in the presence of conc. HNO3, by hydrolysis and refluxing following conventional sol-gel process.

4. The process as claimed in preceding claim, wherein the quantity of Al-Sec-Butoxide, water and concentrated HNO3 are of the order of 40 gm, 300 cc and 1.44 cc respectively, or a similar ratio thereof.

5. The process as claimed in claim 1, wherein curing of the film is effected at a temperature in the range of 450° C. to 500 ° C. attained at a rate of 20 ° C./ hour.

6. The process as claimed in claim 1, wherein the heat treatment of the cured sample with electrodes is effected by firing at a temperature in the range of 800° C. to 850° C. attained at a rate of 50° C./hour.

7. The process as claimed in claim 1, wherein the nanoporous SWCNTs/Al2O3 composite thick film has a dielectric constant of about 50 to 100.

8. The process as claimed in claim 1, wherein the nanoporous SWCNTs/Al2O3 composite thick film has a pore size less than 10 nm.

9. A gas indicator comprising a cured nanoporous SWCNTs/Al2O3 composite thick film and thick film planar electrodes of Ag—Pd.

10. The gas indicator of claim 9, wherein the gas indicator has a sensitivity in the range of 0.5 to 40 ppm level.

11. The gas indicator of claim 9, wherein the gas indicator has a resolution of the order of 0.05 ppm.

12. The gas indicator of claim 9, wherein the gas indicator has a response time <1 minutes.

13. The gas indicator of claim 9, wherein the nanoporous SWCNTs/Al2O3 composite thick film has a dielectric constant of about 50 to 100.

14. The gas indicator of claim 9, wherein the nanoporous SWCNTs/Al2O3 composite thick film has a pore size less than 10 nm.
